(19) United States
(12) Patent Application Publication
(10) Pub. No.: US 2022/0188838 A1
(43) Pub. Date: Jun. 16, 2022

(54) AUTOMATICALLY MONITORING AND REPORTING CAMPAIGN FINANCIAL TRANSACTIONS

(71) Applicant: Schweitzer Laboratories, Inc., New York, NY (US)

(72) Inventors: William Kevin Schweitzer, New York, NY (US); Evan Mark Piro, Ridgewood, NY (US)

(73) Assignee: Schweitzer Laboratories, Inc., New York, NY (US)

(21) Appl. No.: 17/553,030

(22) Filed: Dec. 16, 2021

Related U.S. Application Data
(60) Provisional application No. 63/126,362, filed on Dec. 16, 2020.

(51) Int. Cl. G06Q 30/00; G06Q 20/40

(52) U.S. Cl. CPC G06Q 30/0185; G06Q 20/407

(57) ABSTRACT

A method for automatically monitoring and reporting campaign financial transactions. The method can detect, in real-time, whether non-compliant contribution attributes exist for a campaign financial transaction by identifying campaign-related rules associated with the campaign; and making a determination of whether one or more of the campaign-related rules are triggered. The method further can perform an operation associated with the one or more triggered rules, including terminating the campaign financial transaction without processing the campaign financial transaction; or processing, in real-time, an online payment based on the campaign financial transaction. The method further can create, in response to a payment confirmation for the online payment, a record associated with the campaign financial transaction in a transaction database. The method also can generate, periodically according to a campaign report cycle, a report of records stored in the transaction database based reporting rules associated with the campaign. Other embodiments are also provided.

### CROSS-REFERENCE TO RELATED APPLICATIONS

This application claims priority to U.S. Provisional Patent Application No. 63/126,362, filed Dec. 16, 2020. U.S. Provisional Patent Application No. 63/126,362 is incorporated herein by reference in its entirety.

### TECHNICAL FIELD

This disclosure relates generally to automatically monitoring campaign financial transactions for regulated campaign activities.

### BACKGROUND

Transactions affecting funds of a campaign, such as a political campaign or a charitable organization, are regulated and subject to reporting requirements. Conventional approaches for processing campaign financial transactions, including contributions and disbursements, are not capable of automated compliance checking or reporting. Using conventional approaches, mistakes cannot be easily prevented before the campaign financial transactions are processed and reported. For a campaign, remedial actions to correct mistakes, such as refunds to contributors, requests for refund from vendors, and/or re-creating reports, are mandatory and time-consuming. Moreover, including mistakes in the reports can draw unnecessary suspicion and criticism, and can increase the likelihood that the campaign is audited by the authorities. Therefore, systems and/or methods that can dynamically monitor and report campaign financial transactions so that transactions prohibited by campaign regulations can be prevented before they are processed and reported are desired.

### BRIEF DESCRIPTION OF THE DRAWINGS

To facilitate further description of the embodiments, the following drawings are provided in which:

FIG. 1 illustrates a front elevation view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for automatically monitoring and reporting campaign financial transactions, according to an embodiment;

FIG. 4 illustrates a flow chart for a method for automatically monitoring and reporting a campaign financial transaction, according to an embodiment;

FIG. 5 illustrates a flow chart for a method for automatically monitoring and reporting a campaign contribution transaction, according to another embodiment; and

FIG. 6 illustrates a flow chart for a method for automatically monitoring and reporting a campaign disbursement transaction, according to yet another embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately 0.1 second, 0.5 second, one second, two seconds, five seconds, or ten seconds.

### DESCRIPTION OF EXAMPLES OF EMBODIMENTS

Various embodiments can include a method for automatically monitoring and reporting campaign financial transactions. The method can include receiving, via a computer network from a user device of a user, transaction information for a campaign financial transaction associated with a campaign (e.g., an election campaign, a charity campaign, etc.) and an entity (e.g., a vendor, an individual contributor, a private corporation, a political party committee, etc.). The campaign financial transaction can be a financial transaction between the campaign and the entity. For example, when the entity is a contributor, the campaign financial transaction can be a campaign contribution transaction initiated by the contributor to the campaign, and the user that provides the transaction information can be the contributor or the campaign committee. When the entity is a vendor, the campaign financial transaction can be a campaign disbursement transaction initiated by the campaign to the vendor, and the user that provides the transaction information can be the campaign committee.

The method further can include verifying, in real-time, an identity of the entity. The method can verify the entity identity by any techniques that comply with Known-Your-Customer (KYC) regulations. For example, a digital identity verification can be adopted by checking the entity identifying information of the transaction information (e.g., a name, date of birth, driver license number, address, passport number, business registration number, biometrics, login credentials, etc.) against one or more databases, such as an internal KYC database with verified entity information, authority databases (e.g., government agencies, etc.), and/or third-party KYC services (e.g., credit bureaus, LexisNexis® Risk Solutions, etc.).

In many embodiments, financial transactions associated with the campaign can be regulated, and the method further can include, after the entity identity is verified, determining whether the campaign financial transaction complies with one or more campaign rules according to the applicable laws or regulations of the jurisdiction. Exemplary campaign rules can include one or more contribution-limited-related rules (e.g., the maximum amount an individual is allowed to contribute to a campaign per election or per year, etc.), contributor-related rules (e.g., a foreign entity may not be allowed to contribute to a political campaign, etc.), vendor-related rules (e.g., only certain types of disbursements are allowed, etc.), and so forth. If the campaign financial transaction does not comply with any triggered rule(s) of the one or more campaign rules, the method can stop processing the campaign financial transaction. For example, when one of the campaign rules associated with a campaign is associated with a prohibition of contribution from foreign entities, such rule can be among the triggered rule(s) when the method determines that the contributor of a campaign contribution transaction is a foreign entity, and that accepting the campaign contribution transaction thus can violate the rule.

If it is determined that the campaign financial transaction complies with all applicable campaign rules, the method additionally can include processing the campaign financial transaction. Processing the campaign financial transaction can include: (a) processing, in real-time, an online payment, or (b) processing an off-line payment option. Processing the online payment can include: (i) transmitting, in real-time via the computer network, payment information (e.g., an amount, a credit/debit card number or a bank account for an immediate fund transfer, etc.) for the online payment to a financial institution (e.g., a bank, a credit union, etc.), and (ii) receiving, in real-time via the computer network, the payment confirmation from the financial institution. Processing the off-line payment option can include: (i) recording either a promise to pay of the contributor or a payment entry of the campaign by the off-line payment option, and (ii) receiving, via the computer network, the payment confirmation from the financial institution or a device of the campaign committee.

In a number of embodiments, when the payment confirmation is received, the method further can include creating a record associated with the campaign financial transaction in a transaction database associated with the campaign. The transaction database can include one or more suitable databases, such as a distributed blockchain-based database, a relational database, etc.

In some embodiments, the method also can include generating a report of one or more records stored in the transaction database. The one or more campaign rules further can include one or more reporting rules associated with the campaign, such as a campaign report cycle, the formats of the report, etc. Generating the report can include generating, periodically according to the campaign report cycle, the report based on the reporting rule(s).

In several embodiments, when the campaign financial transaction fails for any of the above reasons (e.g., entity identity not being verified, any campaign rule violations, and/or failed payment authorization), the method additionally can include: (a) storing a log associated with the campaign financial transaction or the triggered rule(s) to a terminated-transaction database, and/or (b) transmitting, via the computer network, an alert to the campaign committee, through any suitable means, such as an email, a text message, a push notification, etc. The terminated-transaction database can include any suitable databases. In certain embodiments, the terminated-transaction database can be identical to or different from the transaction database.

Further, various embodiments can include a system for automatically monitoring and reporting campaign contribution transactions. The system can include one or more processors and one or more non-transitory computer-readable media storing computing instructions that, when executed on the one or more processors, cause the one or more processors to perform various acts. In a number of embodiments, the acts can include detecting, in real-time, whether one or more non-compliant contribution attributes exist for a campaign contribution transaction received via a computer network and initiated by a contributor to a campaign. Detecting whether the one or more non-compliant contribution attributes exist can include: (a) identifying one or more contribution-limit-related rules associated with the campaign, and (b) making a determination of whether at least one of the contributor, the campaign, a contribution amount of the campaign contribution transaction, or an aggregated contribution amount by the contributor is associated with one or more triggered rules of the one or more contribution-limit-related rules.

In a number of embodiments, at least one of the one or more triggered rules of the one or more contribution-limit-related rules can be associated with a contribution limit associated with an entity type of the contributor and the campaign (e.g., $50 for anonymous cash contribution), and/or a sum of the contribution amount of the campaign contribution transaction and the aggregated contribution amount by the contributor in a current campaign cycle (e.g., $10,000 per year for one or more contributions combined by an individual to a local political party committee, or $5,000 per election, etc.).

In some embodiments, detecting whether the one or more non-compliant contribution attributes exist further can include verifying, in real-time, an identity of the contributor by: (i) using a third-party identity verifying service (e.g., LexisNexis® Risk Solutions); and/or (ii) matching contributor identifying information of the campaign contribution transaction with entity data from one or more authority databases (e.g., government agencies' databases).

In many embodiments, detecting whether the one or more non-compliant contribution attributes exist also can include: (a) identifying one or more contributor-related rules associated with the campaign (e.g., nonprofit corporations or federal government contractors can be prohibited to contribute to federal election campaigns), and (b) making a second determination of one or more of: (i) whether the identity of the contributor is verified, or (ii) whether the identity of the contributor or campaign-fraud-related information associated with the contributor is associated with one or more second triggered rules of the one or more contributor-related rules.

In several embodiments, the acts further can include, after detecting whether the one or more non-compliant contribution attributes exist for the campaign contribution transaction, performing, in response to the determination, the second determination, and/or a result of verifying the identity of the contributor, an operation associated with the one or more triggered rules, for the campaign contribution transaction. The operation can include: (a) terminating the campaign contribution transaction without processing the campaign contribution transaction; (b) processing, in real-time, an online payment from the contributor based on the campaign contribution transaction; and/or (c) processing an off-line payment option, depending on the determination, the second determination, and/or a result of verifying the identity of the contributor.

In some embodiments, when the one or more non-compliant contribution attributes exist (e.g., the determination is that the one or more triggered rules exist, the second determination is that the one or more second triggered rules exist, and/or the identity of the contributor is not verified), the option performed can be terminating the campaign contribution transaction. In a few embodiments, terminating the campaign contribution transaction further can include: (a) storing a log associated with the campaign contribution transaction, the one or more triggered rules, or the one or more second triggered rules, to a terminated-transaction database; and/or (b) transmitting, via the computer network, an alert associated with the one or more triggered rules to a campaign committee of the campaign. The alert can include a summary of the log, some or all of the entire content of the log, and/or or a hyperlink to the log. The alert can be in any suitable forms, such as an email, a recorded audio message, etc.

In certain embodiments, the campaign committee can detect campaign fraud attempts by reviewing the alert(s) received and/or access logs in the terminated-transaction database. Once suspicious contributors are identified, the campaign committee can create a list for suspicious contributors or report the suspicious contributors to the proper authorities. In a few embodiments, the acts further can be configured to detect the campaign fraud attempts.

In many embodiments, when the one or more non-compliant contribution attributes do not exist (e.g., the determination is that the one or more triggered rules do not exist, the second determination is that the one or more second triggered rules do not exist, and the identity of the contributor is verified), the operation performed can be: processing, in real-time, an online payment (e.g., a credit/debit card payment or a real-time fund transfer) from the contributor based on the campaign contribution transaction; or processing an off-line payment option (e.g., a check or cash paid onsite). Processing the online payment can include: (a) transmitting, in real-time via the computer network, payment information for the online payment to a financial institution; and (b) receiving, in real-time via the computer network, the payment confirmation from the financial institution. Processing the off-line payment option can include: (a) recording a promise to pay of the contributor by an off-line payment option (e.g., creating a record in a database for pending payments); and (b) receiving, via the computer network, the payment confirmation from a user device of the campaign committee or the financial institution.

In a number of embodiments, after processing occurs for the online or off-line payment, creating, in response to the payment confirmation for the online or off-line payment associated with the operation, a record associated with the campaign contribution transaction in a transaction database associated with the campaign. The transaction database can include one or more suitable databases, such as relational databases, graph-based databases, and/or distributed blockchain-based databases. In several embodiments, the acts further can include generating, periodically according to a campaign report cycle, a report of one or more records, including the record associated with the campaign contribution transaction, stored in the transaction database based on one or more reporting rules associated with the campaign.

In some embodiments, the acts additionally can include updating the campaign rules based on a rule metadata received from a user device (e.g., a personal computer, a mobile device, etc.) via the computer network. The campaign rules can include the one or more contribution-limit-related rules, the contributor-related rules, the campaign reporting rules, one or more vendor-related rules, and so forth. Updating the campaign rules further can include: providing a user interface configured to be executed on the user device of a user (e.g., the campaign committee, a regulator, etc.) for editing the rule metadata for a new rule or an existing rule of the campaign rules. Updating the campaign rules also can include: validating, in response to receipt of the rule metadata from the user device, the rule metadata based on one or more rule schemas (e.g., the type and/or format of a rule attribute); and/or validating consistency of a rule set of one or more rules of the campaign rules associated with the rule metadata. The one or more rules can be grouped into the rule set based on common characteristics of the one or more rules (e.g., state campaign rules or federal campaign rules, or contribution-limit-related rules, etc.). The consistency of the rule set can be validated after the new rule or the existing rule is added to the rule set.

In a number of embodiments, the acts further can include detecting, in real-time, whether one or more non-compliant disbursement attributes exist for a campaign disbursement transaction received via the computer network and initiated by the campaign to a vendor. Detecting whether the one or more non-compliant disbursement attributes exist can include: (a) identifying the one or more vendor-related rules associated with the campaign; and (b) making a disbursement determination of whether the vendor or a disbursement type of the campaign disbursement transaction is associated with one or more disbursement triggered rules of the one or more vendor-related rules.

In certain embodiments, the acts further can include, after detecting whether the one or more non-compliant disbursement attributes exist for the campaign disbursement transaction, performing, in response to the disbursement determination, a disbursement-related operation associated with the one or more disbursement triggered rules, for the campaign disbursement transaction. The disbursement-related operation can include: (a) terminating the campaign disbursement transaction without processing the campaign disbursement transaction; and/or (b) processing, in real-time, a disbursement online payment to the vendor based on the campaign disbursement transaction.

In some embodiments, the acts also can include, after processing occurs for the disbursement online payment, creating, in response to a disbursement payment confirmation for the disbursement online payment associated with the disbursement-related operation, a disbursement record associated with the campaign disbursement transaction in the transaction database associated with the campaign. The one or more records to be included in the report generated further can include the disbursement record after processing occurs for the disbursement online payment.

Further, various embodiments can include a method for automatically monitoring and reporting campaign contribution transactions. The method can being implemented via execution of computing instructions configured to run at one or more processors and stored at one or more non-transitory computer-readable media. The method can include one or more of the acts of the above-mentioned system, such as detecting, in real-time, whether one or more non-compliant contribution attributes exist for a campaign contribution transaction received via a computer network and initiated by a contributor to a campaign; after detecting whether the one or more non-compliant contribution attributes exist for the campaign contribution transaction, performing an operation associated with one or more triggered rules; after processing occurs for an online payment, creating, in response to a payment confirmation for the online payment associated with the operation, a record associated with the campaign contribution transaction in a transaction database associated with the campaign; and/or generating, periodically according to a campaign report cycle, a report of one or more records stored in the transaction database based on one or more reporting rules associated with the campaign.

In addition, various embodiments can include a system for automatically monitoring and reporting campaign disbursement transactions. The system can include one or more processors, and one or more non-transitory computer-readable media storing computing instructions that, when executed on the one or more processors, cause the one or more processors to perform various acts. The acts can include detecting, in real-time, whether one or more non-compliant disbursement attributes exist for a campaign disbursement transaction received via a computer network and initiated by a campaign (e.g., a political campaign or a charity campaign) to a vendor (e.g., a bank, a mail carrier, a print shop, an airline, etc.). Detecting whether one or more non-compliant disbursement attributes exist can include: (a) identifying one or more vendor-related rules associated with the campaign (e.g., whether a vendor is a legitimate business, whether the campaign disbursement transaction is associated with personal use or non-campaign expenses, etc.); and (b) making a determination of whether the vendor or a disbursement type of the campaign disbursement transaction is associated with one or more triggered rules of the one or more vendor-related rules. At least one of the one or more triggered rules can be associated with an entity type of the vendor or the disbursement type of the campaign disbursement transaction.

In a number of embodiments, the acts further can include, after detecting whether the one or more non-compliant disbursement attributes exist for the campaign disbursement transaction, performing, in response to the determination, an operation associated with the one or more triggered rules, for the campaign disbursement transaction. The operation can include: (a) terminating the campaign disbursement transaction without processing the campaign disbursement transaction; or (b) processing, in real-time, an online payment to the vendor based on the campaign disbursement transaction; and after processing occurs for the online payment, creating, in response to a payment confirmation for the online payment associated with the operation, a record associated with the campaign disbursement transaction in a transaction database associated with the campaign.

In some embodiments, the acts also can include generating, periodically according to a campaign report cycle, a report of one or more records stored in the transaction database based on one or more reporting rules associated with the campaign, wherein the one or more records comprise the record after processing occurs for the online payment.

In several embodiments, detecting whether the one or more non-compliant disbursement attributes exist for the campaign disbursement transaction further can include: verifying, in real-time, an identity of the vendor by one or more of: (a) using a third-party identity verifying service (e.g., credit bureaus' KYC services, or LexisNexis® Risk Solutions); or (b) matching vendor identifying information of the campaign disbursement transaction with entity data from one or more authority databases (e.g., internal authority databases or external authority databases, such as databases of the Department of Motor Vehicles of a state). In certain embodiments, terminating the campaign disbursement transaction further can include: terminating the campaign disbursement transaction without processing the campaign disbursement transaction when the identity of the vendor is not verified. Processing the online payment further can include processing, in real-time, the online payment to the vendor based on the campaign disbursement transaction when the identity of the vendor is verified.

In some embodiments, the acts also can include receiving, via the computer network from a campaign device of the campaign, transaction information for the campaign disbursement transaction. The transaction information can include vendor identifying information of the vendor (e.g., vendor's name, address, business registration information, tax identification number (TIN), etc.), campaign identifying information of the campaign (e.g., the campaign's name, year of the election, the political party the campaign is associated with, etc.), the disbursement type (e.g., travel, staff salaries, rent, etc.), and a disbursement amount.

In a number of embodiments, processing the online payment to the vendor based on the campaign disbursement transaction further can include: (a) transmitting, in real-time via the computer network, payment information for the online payment (e.g., credit card number, expiration date, bank account number, etc.) to a financial institution; and (b) receiving, in real-time via the computer network, the payment confirmation from the financial institution.

In some embodiments, the operation for the campaign disbursement transaction further can include: (a) recording a payment entry of the campaign by an off-line payment option (e.g., a check mailed to the vendor); and (b) receiving, via the computer network, the payment confirmation from a financial institution (e.g., a bank maintaining the bank account of and processing payments for the campaign, etc.).

In several embodiments, the acts further can include updating campaign rules based on a rule metadata received from a user device via the computer network. The campaign rules can include the one or more vendor-related rules, contribution-limit-related rules, contributor-related rules, campaign reporting rules, etc. In a few embodiments, updating the campaign rules further can include: (a) providing a user interface configured to be executed on the user device of a user (e.g., a regulator, or the campaign committee) for editing the rule metadata for a new rule or an existing rule of the campaign rules; (b) validating, in response to receipt of the rule metadata from the user device, the rule metadata based on one or more rule schemas (e.g., the type or format of an attribute of a rule); and (c) validating consistency of a rule set of one or more rules, including the new rule or the existing rule, of the campaign rules associated with the rule metadata.

In a number of embodiments, the acts further can include detecting, in real-time, whether one or more non-compliant contribution attributes exist for a campaign contribution transaction received via the computer network and initiated by a contributor to the campaign. Detecting whether one or more non-compliant contribution attributes exist can include identifying: (a) one or more contribution-limit-related rules associated with the campaign, or (b) one or more contributor-related rules associated with the campaign. Detecting whether one or more non-compliant contribution attributes exist further can include making a second determination of: (a) whether at least one of the contributor, the campaign, a contribution amount of the campaign contribution transaction, or an aggregated contribution amount by the contributor is associated with one or more second triggered rules of the one or more contribution-limit-related rules; or (b) whether the identity of the contributor or campaign-fraud-related information associated with the contributor is associated with one or more third triggered rules of the one or more contributor-related rules.

In some embodiments, the acts additionally can include after detecting whether the one or more non-compliant contribution attributes exist for the campaign contribution transaction, performing, a second operation associated with the one or more second triggered rules or the one or more third triggered rules, for the campaign contribution transaction. The second operation can include: (a) terminating the campaign contribution transaction without processing the campaign contribution transaction; or (b) processing, in real-time, a second online payment from the contributor based on the campaign contribution transaction.

In a number of embodiments, the acts also can include after processing occurs for the second online payment, creating, in response to a second payment confirmation for the second online payment associated with the second operation, a second record associated with the campaign contribution transaction in a second transaction database associated with the campaign. In certain embodiments, the second transaction database can be similar or identical to the transaction database. In a few embodiments, second transaction database can be included in the transaction database.

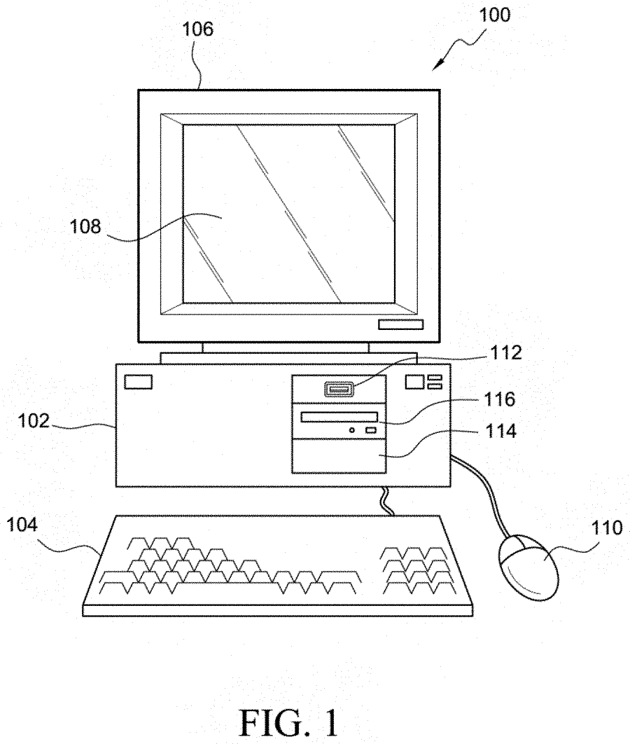

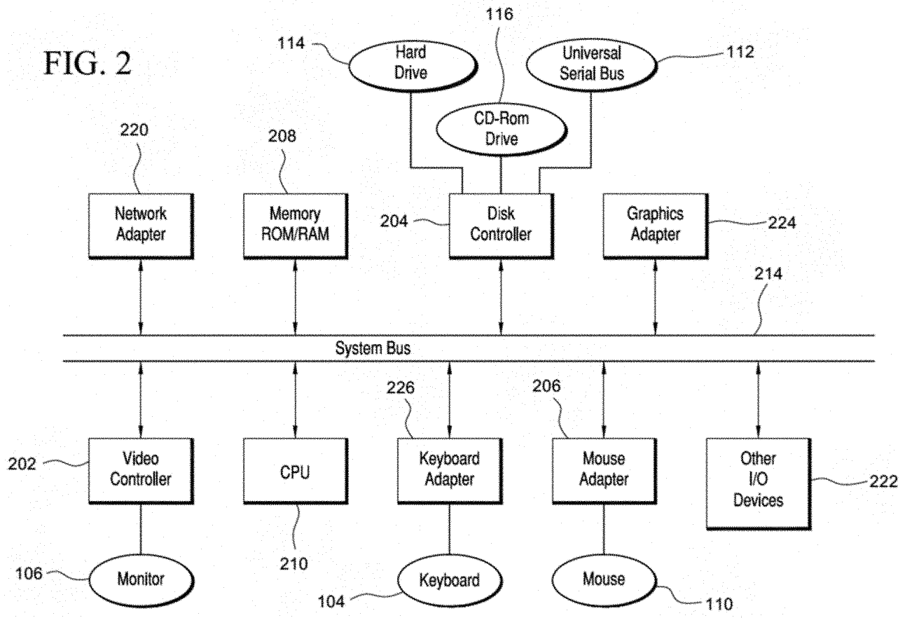

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. (Microsoft) of Redmond, Wash., United States of America, (ii) Mac® OS X by Apple Inc. (Apple) of Cupertino, Calif., United States of America, (iii) UNIX® OS, and (iv) Linux® OS. Further exemplary operating systems can comprise one of the following: (i) the iOS® operating system by Apple, (ii) the Blackberry® operating system by Research In Motion (RIM) of Waterloo, Ontario, Canada, (iii) the WebOS operating system by LG Electronics (LG) of Seoul, South Korea, (iv) the Android™ operating system developed by Google, Inc. (Google) of Mountain View, Calif., United States of America, or (v) the Windows Mobile™ operating system by Microsoft.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computing device 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

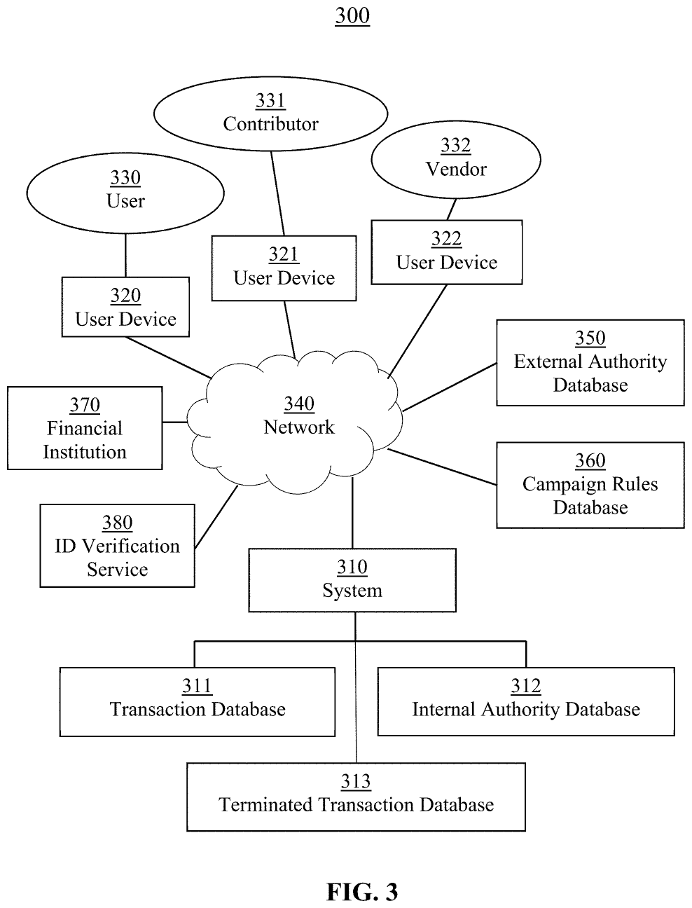

Turning ahead in the drawings, FIG. 3 illustrates a block diagram of a system 300 that can be employed for monitoring and reporting campaign contribution transactions and/or campaign disbursement transactions, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include one or more systems (e.g., system 310, financial institution 370, and/or ID verification service 380) and one or more user devices (e.g., user devices 320, 321, and/or 322) for various users (e.g., a user 330 (e.g., a regulator, the campaign committee, or a system operator), a contributor 331, and/or a vendor 332). System 310, financial institution 370, ID verification service 380, and/or user devices 320, 321, and/or 322 can each be a computer system, such as computer system 100 (FIG. 1), as described above, and can each be a single computer, a single server, or a cluster or collection of computers or servers, or a cloud of computers or servers. In another embodiment, a single computer system can host each of system 310, financial institution 370, ID verification service 380, and/or user devices 320, 321, and/or 322. In many embodiments, system 310, financial institution 370, and/or ID verification service 380 can be modules of computing instructions (e.g., software modules) stored at non-transitory computer readable media that operate on one or more processors. In other embodiments, system 310, financial institution 370, and/or ID verification service 380 can be implemented in hardware. In many embodiments, system 310, financial institution 370, and/or ID verification service 380 can comprise one or more systems, subsystems, modules, or servers. Additional details regarding system 310, financial institution 370, ID verification service 380, and/or user devices 320, 321, and/or 322 are described herein.

In some embodiments, system 310 can be in data communication, through a computer network, a peer-to-peer (P2P) network, a telephone network, or the Internet (e.g., network 340), with user devices 320, 321, and/or 322, financial institution 370, and/or ID verification service 380. In some embodiments, user devices 320, 321, and/or 322 can be used by users, such as user 330 (e.g., a regulator, the campaign committee, or a system operator), contributor 331, and/or vendor 332. In a number of embodiments, system 310 can comprise a front end subsystem that hosts one or more websites and/or mobile application servers. For example, the front end subsystem of system 310 can host a website, or provide a server that interfaces with an application (e.g., a mobile application, a web browser, or a calendar application) on user devices 320, 321, and/or 322, which can allow users, such as user 330, contributor 331, and/or vendor 332, to make contributions, request or handle disbursement payments, access historical contribution or disbursement records, and/or maintain campaign rules, in addition to other suitable activities.

In several embodiments, user 330, contributor 331, and/or vendor 332 can be assigned similar or different access rights to various resources of system 300, including system 310, network 340, one or more databases (e.g., transaction database 311, internal authority database 312, terminated transaction database 313, external authority database 350, and/or campaign rules database 360), and/or user devices (e.g., 320, 321, 322). For example, a regulator (e.g., user 330) can be allowed to access all of the records in transaction database 311 for certain campaigns, maintain internal authority database 312, and/or to read and write some or all records in campaign rules database 360, while a campaign committee can be allowed to access only its own records in transaction database 311.

In some embodiments, an internal network (e.g., network 340) that is not open to the public can be used for communications between system 310 and user devices 320, 321, and/or 322 within system 300. In these or other embodiments, the operator and/or administrator of system 310 can manage system 310, the processor(s) of system 310, and/or the memory storage unit(s) of system 310 using the input device(s) and/or display device(s) of system 310.

In certain embodiments, the user devices (e.g., user devices 320, 321, and/or 322) can be desktop computers, laptop computers, a mobile device, and/or other endpoint devices used by one or more users (e.g., user 330, contributor 331, and/or vendor 332). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Android™ operating system developed by the Open Handset Alliance, or (iv) the Windows Mobile™ operating system by Microsoft Corp. of Redmond, Wash., United States of America.

In many embodiments, system 310 can include one or more input devices (e.g., one or more keyboards, one or more keypads, one or more pointing devices such as a computer mouse or computer mice, one or more touchscreen displays, a microphone, etc.), and/or can comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to system 310 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of system 310. In a similar manner, the processors and/or the non-transitory computer-readable media can be local and/or remote to each other.

Meanwhile, in many embodiments, system 310 also can be configured to communicate with one or more databases (e.g., a transaction database 311, an internal authority database 312, a terminated transaction database 313, an external authority database 350, a campaign rules database 360, etc.). The one or more databases can include a transaction database (e.g., 311) that contains information about historical transactions, including campaign contribution/disbursement transactions, as described below in further detail. The one or more databases further can include an authority database (e.g., internal authority data 312 and/or external authority database 350) that contains KYC information about verified and/or suspicious entity information, as described below in further detail. The one or more databases further can include a terminated transaction database (e.g., 313) that contains information about historical terminated transactions, including campaign contribution/disbursement transactions that were terminated for noncompliance of campaign rules, as described below in further detail. The one or more databases further can include a campaign rules database (e.g., 360) that contains one or more campaign rules, as described below in further detail.

Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases (e.g., transaction database 311, internal authority database 312, terminated transaction database 313, external authority database 350, and/or campaign rules database 360) can each include a structured (e.g., indexed) collection of data and can be managed by any suitable database management systems configured to define, create, query, organize, update, and manage database(s). The one or more databases (e.g., transaction database 311, internal authority database 312, terminated transaction database 313, external authority database 350, and/or campaign rules database 360) can each additionally, or alternatively, be associated with relational databases, distributed databases, centralized databases, hierarchical databases, graph-based databases, multi-dimensional databases, blockchain-based databases, object-oriented databases, cloud-based databases, and/or other types of databases. Exemplary database management systems can include MySQL (Structured Query Language) Database, PostgreSQL Database, Microsoft SQL Server Database, BigchainDB, Postchain, Oracle Database, SAP (Systems, Applications, & Products) Database, and IBM DB2 Database.

Meanwhile, system 300, system 310, and/or the one or more databases (e.g., transaction database 311, internal authority database 312, terminated transaction database 313, external authority database 350, and/or campaign rules database 360) can be implemented using any suitable manner of wired and/or wireless communication. Accordingly, system 300 and/or system 310 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., peer-to-peer (P2P) network protocol(s), personal area network (PAN) protocol(s), local area network (LAN) protocol(s), wide area network (WAN) protocol(s), cellular network protocol(s), powerline network protocol(s), etc.). Exemplary P2P network protocol(s) can include Gnutella, BitTorrent, Kazaa, Napster, etc.; exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, system 310 can detect, in real-time, whether one or more non-compliant contribution attributes exist for a campaign contribution transaction received via a computer network (e.g., 340) and initiated by a contributor (e.g., 331) to a campaign by: (a) identifying one or more contribution-limit-related rules, stored in a campaign rules database (e.g., 360) and associated with the campaign; and (b) making a determination of whether at least one of the contributor, the campaign, a contribution amount of the campaign contribution transaction, or an aggregated contribution amount by the contributor is associated with one or more triggered rules of the one or more contribution-limit-related rules.

In a number of embodiments, system 310 also can, after detecting whether the one or more non-compliant contribution attributes exist for the campaign contribution transaction, perform, in response to the determination, an operation associated with the one or more triggered rules, for the campaign contribution transaction. The operation can include: (a) terminating the campaign contribution transaction without processing the campaign contribution transaction; or (b) processing, in real-time, an online payment from the contributor based on the campaign contribution transaction.

In some embodiments, system 310 further can, after processing occurs for the online payment, create, in response to a payment confirmation for the online payment associated with the operation, a record associated with the campaign contribution transaction in a transaction database (e.g., 311) associated with the campaign. In similar or different embodiments, system 310 can receive the payment confirmation from a financial institution (e.g., 370), via the computer network (e.g., 340), after the financial institution creates the record associated with the campaign contribution transaction in the transaction database (e.g., 311).

In a few embodiments, system 310 additionally can generate, periodically according to a campaign report cycle, a report of one or more records, including stored in the transaction database (e.g., 311) based on one or more reporting rules associated with the campaign, wherein the one or more records comprise the record after processing occurs for the online payment.

Conventional systems are unable to automatically detect, in real-time, one or more non-compliant contribution/disbursement attributes for a campaign contribution/disbursement transaction received via a computer network and then process, in real-time, an online payment from or to the campaign based on the campaign financial transaction. In particular, conventional systems lack the ability to automatically verify the identity of the contributor or vendor and determine, in real-time, one or more triggered rules of the one or more campaign rules associated with the campaign before processing the online payment. In many embodiments, campaign rule checking techniques provided by system 300 and/or system 310 can advantageously address the problem by accessing a campaign rules database (e.g., 360), identifying applicable campaign rules (e.g., contribution-limit-related rules, contributor-related rules, vendor-related rules, etc.) associated with the campaign, and determining whether at least one of the applicable campaign rules is triggered based on the contributor, the vendor, the campaign, the contribution amount, and/or the disbursement type, etc.

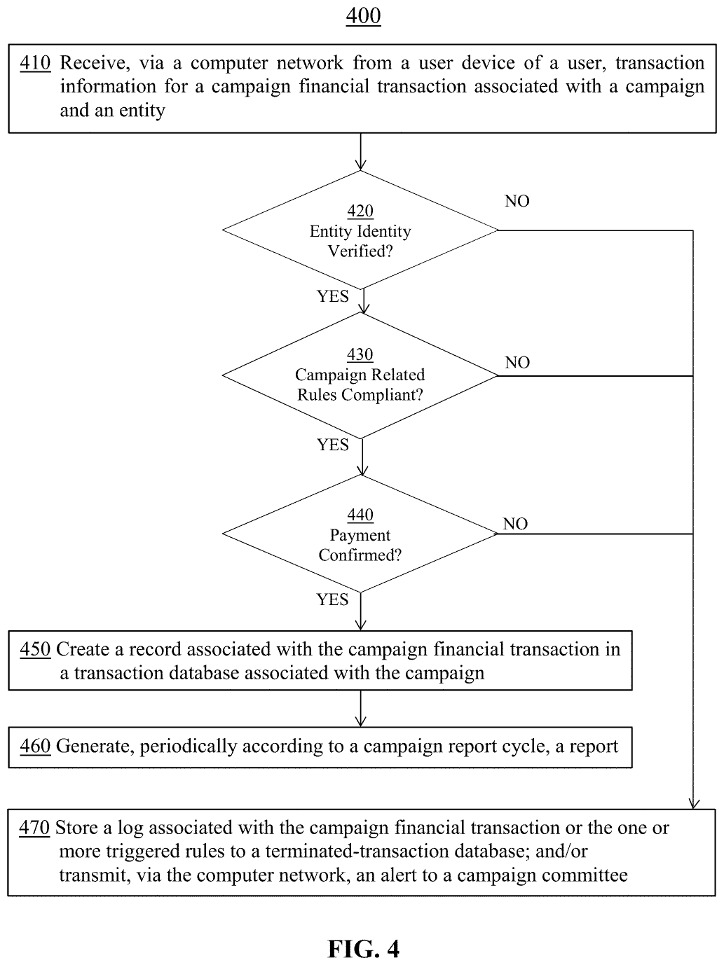

Turning ahead in the drawings, FIG. 4 illustrates a flow chart for a method 400, according to an embodiment. In many embodiments, method 400 can be implemented via execution of computing instructions on one or more processors, and the computing instructions can be stored at one or more non-transitory computer-readable media and, when executed on the one or more processors, cause the one or more processors to perform for automatically monitoring and reporting campaign financial transactions. Method 400 is merely exemplary and is not limited to the embodiments presented herein. Method 400 can be employed in many different embodiments or examples not specifically depicted or described herein. In some embodiments, the procedures, the processes, the activities, and/or the blocks of method 400 can be performed in the order presented. In other embodiments, the procedures, the processes, the activities, and/or the blocks of method 400 can be performed in any suitable order. In still other embodiments, one or more of the procedures, the processes, the activities, and/or the blocks of method 400 can be combined or skipped.

In many embodiments, system 300 (FIG. 3) and/or system 310 (FIG. 3) can be suitable to perform method 400 and/or one or more of the activities of method 400. In these or other embodiments, one or more of the activities of method 400 can be implemented as one or more computing instructions configured to run at one or more processors and configured to be stored at one or more non-transitory computer readable media. Such non-transitory computer readable media can be part of a computer system such as system 300 (FIG. 3) and/or system 310 (FIG. 3). The processor(s) can be similar or identical to the processor(s) described above with respect to computer system 100 (FIG. 1).

Referring to FIG. 4, method 400 can receive, via a computer network (e.g., network 340 (FIG. 3)) from a user device (e.g., user devices 320, 321, and/or 322 (FIG. 3)) of a user (e.g., user 330 (such as a campaign committee, a system operator, or a regulator), contributor 331, or vendor 332 (FIG. 3)), transaction information for a campaign financial transaction associated with a campaign and an entity (e.g., a contributor or a vendor) (block 410).

Method 400 further can verify an entity identity of the entity, by any suitable KYC identity verification techniques, such as using third-party services (e.g., ID verification service 380 (FIG. 3)) or checking against one or more authority databases (e.g., internal or external authority databases 312 or 350 (FIG. 3)) (block 420).

If the identity of the entity is not verified in block 420, then method 400 proceeds to storing a log of the terminated transaction (block 470), as explained below. However, if the entity identity is verified at block 420, method 400 further can detect, in real-time, whether the campaign financial transaction complies with one or more campaign related rules (e.g., contribution-limit-related rules, contributor-related rules, and/or vendor-related rules) (block 430). The campaign related rules can be different between campaign financial transactions for different types of campaigns, campaign contribution transactions and campaign disbursement transactions, campaign contribution transactions initiated by different type of contributors, and so forth. The campaign related rules can be stored in a campaign rules database (e.g., 360 (FIG. 3) and maintained by regulators and/or store operator (e.g., user 330 (FIG. 3)) using a user device (e.g., 320 (FIG. 3)) via the computer network (e.g., network 340 (FIG. 3)).

If the campaign financial transaction is determined to not comply with the one or more campaign related rules in block 430, then method 400 proceeds to storing a log of the terminated transaction (block 470), as explained below. However, if it is determined at block 430 that the campaign financial transaction complies with one or more transaction campaign related rules, method 400 further can process, in real-time, an online payment (e.g., credit/debit card payments, or real-time fund transfers, etc.) from/to the campaign (block 440). In some embodiments, processing the online payment can include: (a) transmitting, in real-time via the computer network, payment information for the online payment to a financial institution; and (b) receiving, in real-time via the computer network, the payment confirmation from the financial institution. In certain embodiments, block 430 also can include processing off-line payment options (e.g., checks or cash), such as recording a promise to pay of the contributor or recording a payment entry of the campaign; and receiving the payment confirmation from the financial institution or the campaign committee. In several embodiments, block 440 further can use a time-out period for processing off-line payment options, such as terminating a campaign financial transaction if the time-out period passes after the promise to pay or the payment entry is recorded before the payment confirmation is received, or sending a reminder to the contributor/user, etc.

Still referring to FIG. 4, after the payment is confirmed at block 440, method 400 further can create a record associated with the campaign financial transaction in a transaction database (e.g., 311 (FIG. 3)) associated with the campaign (block 450). A record associated with a campaign contribution transaction can be similar to or different from a record associated with a campaign disbursement transaction. In some embodiments, creating the record can be done by a system (e.g., 300 or 310 (FIG. 3)) and/or the financial institution processing the payment (e.g., 370 (FIG. 3)). In some embodiments, the record created during block 450 can be part of a blockchain. Furthermore, after the record is created at block 450, method 400 further can generate, periodically according to a campaign report cycle (e.g., every 3 months, a year, or per election), a report of one or more records stored in the transaction database (e.g., 311 (FIG. 3)) based on one or more reporting rules associated with the campaign (e.g., the required information (such as the name of the contributor/vendor, the amount, the type/purpose of the disbursement, etc.) for each record of the one or more records in the report, the format of the report, the filing method of the report, etc.) (block 460). In a few embodiments, more than one record associated with the campaign financial transaction can be created and stored in the transaction database (e.g., 311 (FIG. 3)) at block 450, and the report generated at block 460 can include the more than one record consolidated. In certain embodiments, block 460 further can automatically file the report generated based on the one or more reporting rules, with or without an approval by the campaign committee (e.g., user 330 (FIG. 3)) via a user device (e.g., 320 (FIG. 3)).

In a number of embodiments, method 400 additionally can store a log associated with the campaign financial transaction that is terminated at blocks 420, 430, and/or 440 (block 470). The log can include information relating to the campaign financial transaction and/or one or more triggered rules of the pertinent campaign related rules to a terminated-transaction database (e.g., 313 (FIG. 3)). In some embodiments, block 470 can include creating a blockchain record for the terminated campaign financial transaction, and the log can be part of the blockchain. In the same or different embodiments, block 470 additionally or alternatively can transmit, via the computer network (e.g., network 340 (FIG. 3)), an alert to a campaign committee (e.g., user 330 (FIG. 3)) so that the campaign committee is aware of the campaign financial transaction that fails and/or the reason(s) of such failure.

In a number of embodiments, method 400 additionally can update the campaign related rules based on a rule metadata received from a user device (e.g., 330 (FIG. 3)) via the computer network (e.g., network 340 (FIG. 3)). The campaign related rules can include the one or more contribution-limit-related rules, the contributor-related rules, the campaign reporting rules, and/or the one or more vendor-related rules. The campaign related rules can be stored in a campaign rules database (e.g., 360 (FIG. 3)). Updating the campaign related rules further can include: providing a user interface configured to be executed on the user device (e.g., 320 (FIG. 3)) of a user (e.g., 330 (FIG. 3), one or more regulators, law enforcements, etc.) for editing the rule metadata for a new rule or an existing rule of the campaign related rules. Updating the campaign related rules also can include: validating, in response to receipt of the rule metadata from the user device (e.g., 320 (FIG. 3)), the rule metadata based on one or more rule schemas (e.g., the format of an attribute of a rule); and/or validating consistency of a rule set of one or more rules of the campaign related rules associated with the rule metadata. The one or more rules can be grouped into the rule set based on common characteristics of the one or more rules (e.g., state campaign rules or federal campaign rules, rules related to contribution amount, or rules related to disbursement types, etc.). The consistency of the rule set can be validated after the new rule or the existing rule is added to the rule set.

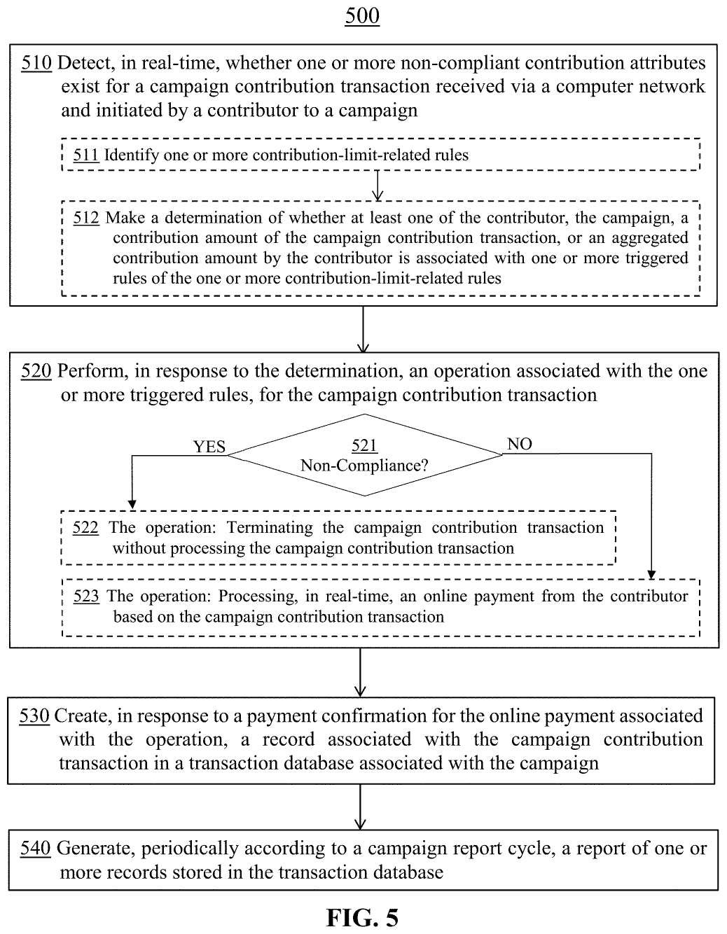

Turning ahead in the drawings, FIG. 5 illustrates a flow chart for a method 500, according to an embodiment. In many embodiments, method 500 can be implemented via execution of computing instructions on one or more processors, and the computing instructions can be stored at one or more non-transitory computer-readable media and, when executed on the one or more processors, cause the one or more processors to perform automatically monitoring and reporting campaign contribution transactions. Method 500 is merely exemplary and is not limited to the embodiments presented herein. Method 500 can be employed in many different embodiments or examples not specifically depicted or described herein. In some embodiments, the procedures, the processes, the activities, and/or the blocks of method 500 can be performed in the order presented. In other embodiments, the procedures, the processes, the activities, and/or the blocks of method 500 can be performed in any suitable order. In still other embodiments, one or more of the procedures, the processes, the activities, and/or the blocks of method 500 can be combined or skipped. In a number of embodiments, some or all of the procedures, the processes, the activities, and/or the blocks of method 500 can be similar or identical to some or all of the procedures, the processes, the activities, and/or the blocks of method 400 (FIG. 4).

In many embodiments, system 300 (FIG. 3) and/or system 310 (FIG. 3) can be suitable to perform method 500 and/or one or more of the activities of method 500. In these or other embodiments, one or more of the activities of method 500 can be implemented as one or more computing instructions configured to run at one or more processors and configured to be stored at one or more non-transitory computer readable media. Such non-transitory computer readable media can be part of a computer system such as system 300 (FIG. 3) and/or system 310 (FIG. 3). The processor(s) can be similar or identical to the processor(s) described above with respect to computer system 100 (FIG. 1).

Referring to FIG. 5, method 500 can detect in real-time, whether one or more non-compliant contribution attributes exist for a campaign contribution transaction received via a computer network (e.g., network 340 (FIG. 3)) and initiated by a contributor (e.g., 331 (FIG. 3)) to a campaign (block 510). In some embodiments, detecting whether the one or more non-compliant contribution attributes exist at block 510 can include: (a) identifying one or more contribution-limit-related rules associated with the campaign (block 511); and (b) making a determination of whether at least one of the contributor, the campaign, a contribution amount of the campaign contribution transaction, or an aggregated contribution amount by the contributor is associated with one or more triggered rules of the one or more contribution-limit-related rules (block 512). Example of the one or more contribution-limit-related rules associated with the campaign can include the respective maximum amount that an individual, a limited liability company, a political party, etc. can contribute, in a single campaign contribution transaction or multiple campaign contribution transactions combined in a year or a campaign cycle (e.g., 2 years, 3 years, etc.), to a campaign of a certain type that matches the campaign's type (e.g., a candidate campaign or a political party campaign in a state or nationwide).

In some embodiments, block 510 further can include: (a) (i) verifying, in real-time, an identity of the contributor by one or more of: using a third-party identity verifying service (e.g., LexisNexis® Risk Solutions, or ID verification service 380 (FIG. 3)); or matching contributor identifying information of the campaign contribution transaction with entity data from one or more authority databases (e.g., internal/external authority databases 312 and/or 350 (FIG. 3)); or (ii) identifying one or more contributor-related rules associated with the campaign; and (b) making a second determination of one or more of: (i) whether the identity of the contributor is verified, or (ii) whether the identity of the contributor or campaign-fraud-related information (e.g., prior fraud activities or a previous conviction of campaign fraud) associated with the contributor is associated with one or more second triggered rules of the one or more contributor-related rules. Examples of contributor-related rules can include who can or cannot contribute to a specific type of campaign, such as a charity organization being prohibited from contributing to a political campaign.

In many embodiments, method 500 further can perform, after block 510, in response to the determination or the second determination at block 510/512, an operation associated with the one or more triggered rules, for the campaign contribution transaction (block 520). In some embodiments, the one or more contribution-limit-related rules and/or the one or more contributor-related rules associated with the campaign can be stored in a campaign rules database (e.g., 360 (FIG. 3)), and each of the one or more triggered rules or second triggered rules further can include or be associated with a respective operation option to be performed when such rule is triggered.

When method 500 decides that the determination at block 510/512 is that the one or more non-compliant contribution attributes exist (block 521), method 500 can perform the operation-terminating the campaign contribution transaction without processing the campaign contribution transaction (block 522). Block 522 can be similar or identical to block 470 (FIG. 4) and/or include some or all of the above-mentioned activities of block 470 (FIG. 4). In a number of embodiments, block 522 further can include: (a) storing a log associated with the campaign contribution transaction, the one or more triggered rules, or the one or more second triggered rules, to a terminated-transaction database (e.g., 313 (FIG. 3)); and/or (b) transmitting, via the computer network (e.g., network 340 (FIG. 3)), an alert associated with the one or more triggered rules to a campaign committee of the campaign.

When method 500 decides that the determination at block 512 is that the one or more non-compliant contribution attributes do not exist (block 521), method 500 can perform the operation-processing, in real-time, an online payment from the contributor based on the campaign contribution transaction (block 523). Block 523 can be similar or identical to block 440 (FIG. 4) and/or include some or all of the above-mentioned activities of block 440 (FIG. 4). In a number of embodiments, block 523 can perform: processing the online payment (e.g., a credit card payment, an automated clearing house (ACH) payment, or a real-time fund transfer, etc.) by: (a) transmitting, in real-time via the computer network (e.g., network 340 (FIG. 3)), payment information for the online payment to a financial institution (e.g., 370 (FIG. 3)); and (b) receiving, in real-time via the computer network, the payment confirmation from the financial institution. Block 523 further can perform: processing off-line payment options (e.g., checks or cash), such as recording a promise to pay of the contributor; and receiving the payment confirmation from the financial institution or a user device (e.g., 320 (FIG. 3)) of a user (e.g., 330 (FIG. 3), the campaign committee of the campaign, or a system operator, etc.).

In a number of embodiments, method 500 also can create, in response to a payment confirmation for the online payment, or off-line payment option, associated with the operation, a record associated with the campaign contribution transaction in a transaction database (e.g., 311 (FIG. 3)) associated with the campaign (block 530). Block 530 can be similar or identical to block 450 (FIG. 4) and/or include some or all of the above-mentioned activities of block 450 (FIG. 4). In several embodiments, method 500 further can generate, periodically according to a campaign report cycle, a report of one or more records stored in the transaction database (e.g., 311 (FIG. 3)) (block 540). Block 540 can be similar or identical to block 460 (FIG. 4) and/or include some or all of the above-mentioned activities of block 460 (FIG. 4).

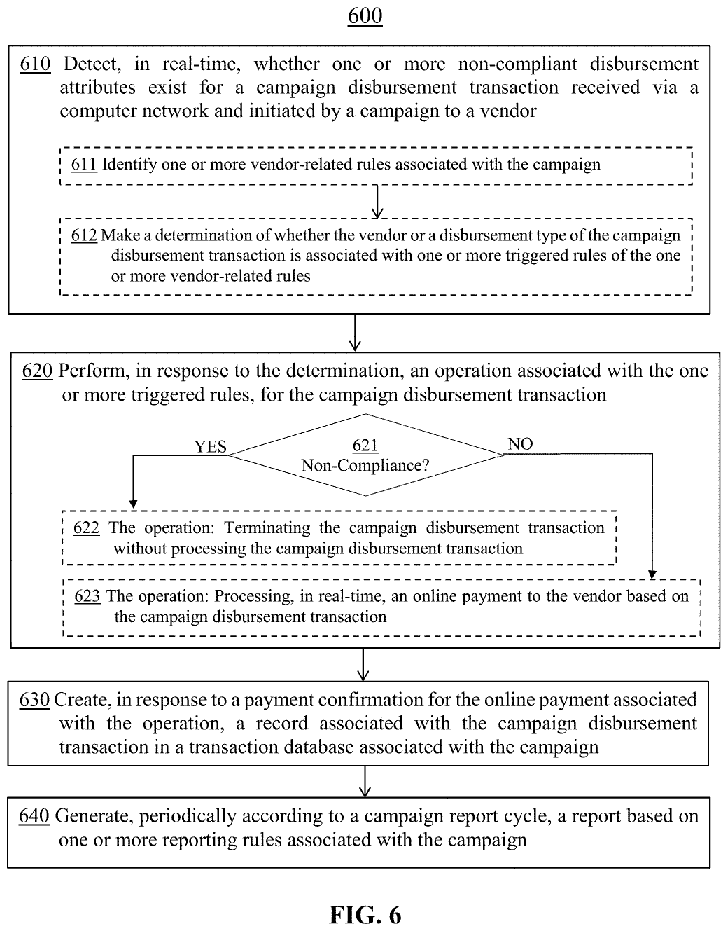

Turning ahead in the drawings, FIG. 6 illustrates a flow chart for a method 600, according to an embodiment. In many embodiments, method 600 can be implemented via execution of computing instructions on one or more processors, and the computing instructions can be stored at one or more non-transitory computer-readable media and, when executed on the one or more processors, cause the one or more processors to perform automatically monitoring and reporting campaign disbursement transactions. Method 600 is merely exemplary and is not limited to the embodiments presented herein. Method 600 can be employed in many different embodiments or examples not specifically depicted or described herein. In some embodiments, the procedures, the processes, the activities, and/or the blocks of method 600 can be performed in the order presented. In other embodiments, the procedures, the processes, the activities, and/or the blocks of method 600 can be performed in any suitable order. In still other embodiments, one or more of the procedures, the processes, the activities, and/or the blocks of method 600 can be combined or skipped. In a number of embodiments, some or all of the procedures, the processes, the activities, and/or the blocks of method 600 can be similar or identical to some or all of the procedures, the processes, the activities, and/or the blocks of method 400 (FIG. 4) and/or method 500 (FIG. 5).

In many embodiments, system 300 (FIG. 3) and/or system 310 (FIG. 3) can be suitable to perform method 600 and/or one or more of the activities of method 600. In these or other embodiments, one or more of the activities of method 600 can be implemented as one or more computing instructions configured to run at one or more processors and configured to be stored at one or more non-transitory computer readable media. Such non-transitory computer readable media can be part of a computer system such as system 300 (FIG. 3) and/or system 310 (FIG. 3). The processor(s) can be similar or identical to the processor(s) described above with respect to computer system 100 (FIG. 1).

Referring to FIG. 6, method 600 can detect in real-time, whether one or more non-compliant disbursement attributes exist for a campaign disbursement transaction received via a computer network (e.g., network 340 (FIG. 3)) and initiated by a campaign to a vendor (e.g., 332 (FIG. 3)) (block 610). In some embodiments, detecting whether the one or more non-compliant contribution attributes exist at block 610 further can include: (a) identifying one or more vendor-related rules associated with the campaign (block 611); and (b) making a determination of whether at least one of the vendor, or a disbursement type of the campaign disbursement transaction is associated with one or more triggered rules of the one or more vendor-related rules (block 612). For example, one of the vendor-related rules associated with the campaign can include a prohibition of disbursement for travel expenses unrelated to campaign activities, and when a campaign disbursement transaction is associated with an invoice from a travel agent for a personal trip of the candidate's family, block 612 can determine that such rule is among the one or more triggered rules.

In a number of embodiments, block 610 further can include: verifying, in real-time, an identity of the vendor; or identifying one or more contributor-related rules associated with the campaign. Verifying the identity of the vendor at block 610 can be similar or identical to some or all of the identity verification activities of block 420 (FIG. 4) and/or block 510 (FIG. 5).

In many embodiments, method 600 further can perform, after block 610, in response to the determination at block 612 or the verification of vendor identity at block 610, an operation associated with the one or more triggered rules, for the campaign disbursement transaction (block 620). In several embodiments, each of the one or more vendor-related rules can include or be associated with a respective operation option to be performed when such rule is triggered.

When method 600 decides that the determination at block 610/612 is that the one or more non-compliant disbursement attributes exist (block 621), method 600 can perform the operation-terminating the campaign disbursement transaction without processing the campaign disbursement transaction (block 622). Block 622 can be similar or identical to block 470 (FIG. 4) and/or block 522 (FIG. 5) and/or include some or all of the above-mentioned activities of block 470 (FIG. 4) and/or block 522 (FIG. 5), such as creating a log associated with the campaign disbursement transaction, or the one or more triggered rules to a terminated-transaction database (e.g., 313 (FIG. 3)); and/or transmitting, via the computer network (e.g., network 340 (FIG. 3)), an alert associated with the one or more triggered rules to the campaign committee of the campaign.

Further, when method 600 decides that the determination at block 612 is that the one or more non-compliant disbursement attributes do not exist (block 621), method 600 can perform the operation-processing, in real-time, an online payment (e.g., a credit card payment, an automated clearing house (ACH) payment to the vendor based on the campaign disbursement transaction (block 623). In a number of embodiments, block 623 further can process an off-line payment option (e.g., checks or cash). Block 623 can be similar or identical to block 440 (FIG. 4) and/or block 523 (FIG. 5) and/or include some or all of the above-mentioned activities of block 440 (FIG. 4) and/or block 523 (FIG. 5) for processing disbursement payments.

In a number of embodiments, method 600 also can create, in response to a payment confirmation for the online payment, or off-line payment option, associated with the operation, a record associated with the campaign disbursement transaction in a transaction database (e.g., 311 (FIG. 3)) associated with the campaign (block 630). Block 630 can be similar or identical to block 450 (FIG. 4) and/or block 530 (FIG. 5) and/or include some or all of the above-mentioned activities of block 450 (FIG. 4) and/or block 530 (FIG. 5) for creating a record associated with the campaign financial transaction. A record associated with a campaign disbursement transaction can be similar to or different from a record associated with a campaign contribution transaction.

In several embodiments, method 600 further can generate, periodically according to a campaign report cycle, a report of one or more records stored in the transaction database (e.g., 311 (FIG. 3)) (block 640). Block 640 can be similar or identical to block 460 (FIG. 4) and/or block 540 (FIG. 5) and/or include some or all of the above-mentioned activities of block 460 (FIG. 4) and/or block 540 (FIG. 5).

In some embodiments, method 600 further can include one or more procedures, processes, activities, or blocks of method 500 (FIG. 5) for processing campaign contribution transactions. Method 600 also can provide a user interface to be executed on a user device (e.g., 320 (FIG. 3)) of a user (e.g., 330 (FIG. 3) or a regulator) for the user can maintain the campaign rules database (e.g., 360 (FIG. 3)) and/or automatically ensure the consistency of the campaign related rules in the campaign rules database, as provided above.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

In many embodiments, the techniques for detecting, in real-time, whether one or more non-compliant contribution/disbursement attributes exist for a campaign financial transaction can advantageously address the risk of campaign frauds or human mistakes before processing, in real-time, online payments associated with campaign financial transactions. Although the system and/or method disclosed here are capable of processing off-line payments, online payments have become the major payment methods for campaign financial transactions. With such detection techniques in place, the system or method can ensure, in real-time, that non-compliance in the campaign financial transactions and/or reports can be reduced, and campaign frauds by the campaign, contributors, and/or vendors can be prevented when applicable campaign rules are automatically applied without bias or human errors.

In a number of embodiments, the techniques described herein can solve a technical problem that arises only within the realm of computer networks, as system or method for processing online campaign financial transactions do not exist outside the realm of computer networks. Moreover, the techniques described herein can solve a technical problem that cannot be solved outside the context of computer networks. Specifically, the techniques described herein cannot be used outside the context of computer networks, in view of a lack of data, and a lack of access to a third-party identity verifying service, authority databases, and online payment processing capabilities.

The foregoing is provided for purposes of illustrating, explaining, and describing embodiments of these disclosures. Modifications and adaptations to these embodiments will be apparent to those skilled in the art and may be made without departing from the scope or spirit of these disclosures.

Although automatically monitoring and reporting campaign contribution and/or disbursement transactions has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-2 may be modified, and that the foregoing discussion of certain of these embodiments does not necessarily represent a complete description of all possible embodiments.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions that, when executed on the one or more processors, cause the one or more processors to perform:
detecting, in real-time, whether one or more non-compliant contribution attributes exist for a campaign contribution transaction received via a computer network and initiated by a contributor to a campaign by:
identifying one or more contribution-limit-related rules associated with the campaign; and
making a determination of whether at least one of the contributor, the campaign, a contribution amount of the campaign contribution transaction, or an aggregated contribution amount by the contributor is associated with one or more triggered rules of the one or more contribution-limit-related rules;
after detecting whether the one or more non-compliant contribution attributes exist for the campaign contribution transaction, performing, in response to the determination, an operation associated with the one or more triggered rules, for the campaign contribution transaction, wherein the operation comprises:
terminating the campaign contribution transaction without processing the campaign contribution transaction; or
processing, in real-time, an online payment from the contributor based on the campaign contribution transaction;
after processing occurs for the online payment, creating, in response to a payment confirmation for the online payment associated with the operation, a record associated with the campaign contribution transaction in a transaction database associated with the campaign; and
generating, periodically according to a campaign report cycle, a report of one or more records stored in the transaction database based on one or more reporting rules associated with the campaign, wherein the one or more records comprise the record after processing occurs for the online payment.

2. The system in claim 1, wherein:
detecting whether the one or more non-compliant contribution attributes exist for the campaign contribution transaction further comprises:
one or more of:
(a) verifying, in real-time, an identity of the contributor by one or more of:
using a third-party identity verifying service; or matching contributor identifying information of the campaign contribution transaction with entity data from one or more authority databases; or
(b) identifying one or more contributor-related rules associated with the campaign; and
making a second determination of one or more of: (a) whether the identity of the contributor is verified, or (b) whether the identity of the contributor or campaign-fraud-related information associated with the contributor is associated with one or more second triggered rules of the one or more contributor-related rules;
terminating the campaign contribution transaction further comprises:
terminating the campaign contribution transaction without processing the campaign contribution transaction when the second determination is made; and
processing the online payment further comprises:
processing, in real-time, the online payment from the contributor based on the campaign contribution transaction when the second determination is not made.

3. The system in claim 2, wherein detecting whether the one or more non-compliant contribution attributes exist for the campaign contribution transaction further comprises requesting, in real-time via the computer network, the campaign-fraud-related information associated with the contributor from the one or more authority databases.

4. The system in claim 1, wherein the computing instructions, when executed on the one or more processors, further cause the one or more processors to perform:
receiving, via the computer network from a contributor device of the contributor, transaction information for the campaign contribution transaction, wherein the transaction information comprises contributor identifying information of the contributor, campaign identifying information of the campaign, and the contribution amount.

5. The system in claim 1, wherein processing the online payment from the contributor based on the campaign contribution transaction further comprises:
transmitting, in real-time via the computer network, payment information for the online payment to a financial institution; and
receiving, in real-time via the computer network, the payment confirmation from the financial institution.

6. The system in claim 1, wherein the operation further comprises:
recording a promise to pay of the contributor by an off-line payment option; and
receiving, via the computer network, the payment confirmation from a user device or a financial institution.

7. The system in claim 1, wherein:
the computing instructions, when executed on the one or more processors, further cause the one or more processors to perform updating campaign rules based on a rule metadata received from a user device via the computer network; and
the campaign rules comprise the one or more contribution-limit-related rules.

8. The system in claim 7, wherein updating the campaign rules further comprises:
providing a user interface configured to be executed on the user device of a user for editing the rule metadata for a new rule or an existing rule of the campaign rules;
validating, in response to receipt of the rule metadata from the user device, the rule metadata based on one or more rule schemas; and
validating consistency of a rule set of one or more rules of the campaign rules associated with the rule metadata, wherein:
the rule set further comprises the new rule or the existing rule.

9. The system in claim 1, wherein:
at least one of the one or more triggered rules is associated with a contribution limit associated with an entity type of the contributor and the campaign; and
a sum of the contribution amount of the campaign contribution transaction and the aggregated contribution amount by the contributor in a current campaign cycle.

10. The system in claim 1, wherein terminating the campaign contribution transaction further comprises one or more of:
storing a log associated with the campaign contribution transaction or the one or more triggered rules to a terminated-transaction database; or
transmitting, via the computer network, an alert associated with the one or more triggered rules to a campaign committee of the campaign.

11. The system in claim 1, wherein:
the computing instructions, when executed on the one or more processors, further cause the one or more processors to perform:
detecting, in real-time, whether one or more non-compliant disbursement attributes exist for a campaign disbursement transaction received via the computer network and initiated by the campaign to a vendor by:
identifying one or more vendor-related rules associated with the campaign; and
making a disbursement determination of whether the vendor or a disbursement type of the campaign disbursement transaction is associated with one or more disbursement triggered rules of the one or more vendor-related rules;
after detecting whether the one or more non-compliant disbursement attributes exist for the campaign disbursement transaction, performing, in response to the disbursement determination, a disbursement-related operation associated with the one or more disbursement triggered rules, for the campaign disbursement transaction, wherein the disbursement-related operation comprises:
terminating the campaign disbursement transaction without processing the campaign disbursement transaction; or
processing, in real-time, a disbursement online payment to the vendor based on the campaign disbursement transaction; and
after processing occurs for the disbursement online payment, creating, in response to a disbursement payment confirmation for the disbursement online payment associated with the disbursement-related operation, a disbursement record associated with the campaign disbursement transaction in the transaction database associated with the campaign; and
the one or more records further comprise the disbursement record after processing occurs for the disbursement online payment.

12. A method being implemented via execution of computing instructions configured to run at one or more processors and stored at one or more non-transitory computer-readable media, the method comprising:
detecting, in real-time, whether one or more non-compliant contribution attributes exist for a campaign contribution transaction received via a computer network and initiated by a contributor to a campaign by:
identifying one or more contribution-limit-related rules associated with the campaign; and
making a determination of whether at least one of the contributor, the campaign, a contribution amount of the campaign contribution transaction, or an aggregated contribution amount by the contributor is associated with one or more triggered rules of the one or more contribution-limit-related rules;
after detecting whether the one or more non-compliant contribution attributes exist for the campaign contribution transaction, performing, in response to the determination, an operation associated with the one or more triggered rules, for the campaign contribution transaction, wherein the operation comprises:
terminating the campaign contribution transaction without processing the campaign contribution transaction; or
processing, in real-time, an online payment from the contributor based on the campaign contribution transaction;
after processing occurs for the online payment, creating, in response to a payment confirmation for the online payment associated with the operation, a record associated with the campaign contribution transaction in a transaction database associated with the campaign; and
generating, periodically according to a campaign report cycle, a report of one or more records stored in the transaction database based on one or more reporting rules associated with the campaign, wherein the one or more records comprise the record after processing occurs for the online payment.

13. The method in claim 12, wherein:
detecting whether the one or more non-compliant contribution attributes exist for the campaign contribution transaction further comprises:
one or more of:
(a) verifying, in real-time, an identity of the contributor by one or more of:
using a third-party identity verifying service; or matching contributor identifying information of the campaign contribution transaction with entity data from one or more authority databases; or
(b) identifying one or more contributor-related rules associated with the campaign; and
making a second determination of one or more of: (a) whether the identity of the contributor is verified, or (b) whether the identity of the contributor or campaign-fraud-related information associated with the contributor is associated with one or more second triggered rules of the one or more contributor-related rules;
terminating the campaign contribution transaction further comprises:
terminating the campaign contribution transaction without processing the campaign contribution transaction when the second determination is made; and
processing the online payment further comprises:
processing, in real-time, the online payment from the contributor based on the campaign contribution transaction when the second determination is not made.

14. The method in claim 13, wherein detecting whether the one or more non-compliant contribution attributes exist for the campaign contribution transaction further comprises requesting, in real-time via the computer network, the campaign-fraud-related information associated with the contributor from the one or more authority databases.

15. The method in claim 12 further comprising:
receiving, via the computer network from a contributor device of the contributor, transaction information for the campaign contribution transaction, wherein the transaction information comprises contributor identifying information of the contributor, campaign identifying information of the campaign, and the contribution amount.

16. The method in claim 12, wherein processing the online payment from the contributor based on the campaign contribution transaction further comprises:
transmitting, in real-time via the computer network, payment information for the online payment to a financial institution; and
receiving, in real-time via the computer network, the payment confirmation from the financial institution.

17. The method in claim 12, wherein the operation further comprises:
recording a promise to pay of the contributor by an off-line payment option; and
receiving, via the computer network, the payment confirmation from a user device or a financial institution.

18. The method in claim 12 further comprising updating campaign rules based on a rule metadata received from a user device via the computer network, wherein:
the campaign rules comprise the one or more contribution-limit-related rules.

19. The method in claim 18, wherein updating the campaign rules further comprises:
providing a user interface configured to be executed on the user device of a user for editing the rule metadata for a new rule or an existing rule of the campaign rules;
validating, in response to receipt of the rule metadata from the user device, the rule metadata based on one or more rule schemas; and
validating consistency of a rule set of one or more rules of the campaign rules associated with the rule metadata, wherein:
the rule set further comprises the new rule or the existing rule.

20. The method in claim 12, wherein at least one of the one or more triggered rules is associated with a contribution limit associated with an entity type of the contributor and the campaign; and a sum of the contribution amount of the campaign contribution transaction and the aggregated contribution amount by the contributor in a current campaign cycle.

21. The method in claim 12, wherein terminating the campaign contribution transaction further comprises one or more of:
storing a log associated with the campaign contribution transaction or the one or more triggered rules to a terminated-transaction database; or
transmitting, via the computer network, an alert associated with the one or more triggered rules to a campaign committee of the campaign.

22. The method in claim 12 further comprising:
detecting, in real-time, whether one or more non-compliant disbursement attributes exist for a campaign disbursement transaction received via the computer network and initiated by the campaign to a vendor by:
identifying one or more vendor-related rules associated with the campaign; and
making a disbursement determination of whether the vendor or a disbursement type of the campaign disbursement transaction is associated with one or more disbursement triggered rules of the one or more vendor-related rules;
after detecting whether the one or more non-compliant disbursement attributes exist for the campaign disbursement transaction, performing, in response to the disbursement determination, a disbursement-related operation associated with the one or more disbursement triggered rules, for the campaign disbursement transaction, wherein the disbursement-related operation comprises:
terminating the campaign disbursement transaction without processing the campaign disbursement transaction; or
processing, in real-time, a disbursement online payment to the vendor based on the campaign disbursement transaction; and
after processing occurs for the disbursement online payment, creating, in response to a disbursement payment confirmation for the disbursement online payment associated with the disbursement-related operation, a disbursement record associated with the campaign disbursement transaction in the transaction database associated with the campaign,
wherein:
the one or more records further comprise the disbursement record after processing occurs for the disbursement online payment.

23. A system comprising:
one or more processors; and
one or more non-transitory computer-readable media storing computing instructions that, when executed on the one or more processors, cause the one or more processors to perform:
detecting, in real-time, whether one or more non-compliant disbursement attributes exist for a campaign disbursement transaction received via a computer network and initiated by a campaign to a vendor by:
identifying one or more vendor-related rules associated with the campaign; and
making a determination of whether the vendor or a disbursement type of the campaign disbursement transaction is associated with one or more triggered rules of the one or more vendor-related rules;
after detecting whether the one or more non-compliant disbursement attributes exist for the campaign disbursement transaction, performing, in response to the determination, an operation associated with the one or more triggered rules, for the campaign disbursement transaction, wherein the operation comprises:
terminating the campaign disbursement transaction without processing the campaign disbursement transaction; or
processing, in real-time, an online payment to the vendor based on the campaign disbursement transaction;
after processing occurs for the online payment, creating, in response to a payment confirmation for the online payment associated with the operation, a record associated with the campaign disbursement transaction in a transaction database associated with the campaign; and
generating, periodically according to a campaign report cycle, a report of one or more records stored in the transaction database based on one or more reporting rules associated with the campaign, wherein the one or more records comprise the record after processing occurs for the online payment.

24. The system in claim 23, wherein:
detecting whether the one or more non-compliant disbursement attributes exist for the campaign disbursement transaction further comprises verifying, in real-time, an identity of the vendor by one or more of:
using a third-party identity verifying service; or
matching vendor identifying information of the campaign disbursement transaction with entity data from one or more authority databases;
terminating the campaign disbursement transaction further comprises:
terminating the campaign disbursement transaction without processing the campaign disbursement transaction when the identity of the vendor is not verified; and
processing the online payment further comprises:
processing, in real-time, the online payment to the vendor based on the campaign disbursement transaction when the identity of the vendor is verified.

25. The system in claim 23, wherein:
the computing instructions, when executed on the one or more processors, further cause the one or more processors to perform receiving, via the computer network from a campaign device of the campaign, transaction information for the campaign disbursement transaction; and
the transaction information comprises vendor identifying information of the vendor, campaign identifying information of the campaign, the disbursement type, and a disbursement amount.

26. The system in claim 23, wherein processing the online payment to the vendor based on the campaign disbursement transaction further comprises:
transmitting, in real-time via the computer network, payment information for the online payment to a financial institution; and
receiving, in real-time via the computer network, the payment confirmation from the financial institution.

27. The system in claim 23, wherein the operation further comprises:
recording a payment entry of the campaign by an off-line payment option; and
receiving, via the computer network, the payment confirmation from a financial institution.

28. The system in claim 23, wherein:
the computing instructions, when executed on the one or more processors, further cause the one or more processors to perform updating campaign rules based on a rule metadata received from a user device via the computer network; and
the campaign rules comprise the one or more vendor-related rules.

29. The system in claim 28, wherein updating the campaign rules further comprises:
providing a user interface configured to be executed on the user device of a user for editing the rule metadata for a new rule or an existing rule of the campaign rules;
validating, in response to receipt of the rule metadata from the user device, the rule metadata based on one or more rule schemas; and
validating consistency of a rule set of one or more rules of the campaign rules associated with the rule metadata, wherein:
the rule set further comprises the new rule or the existing rule.

30. The system in claim 23, wherein at least one of the one or more triggered rules is associated with an entity type of the vendor or the disbursement type of the campaign disbursement transaction.

31. The system in claim 23, wherein:
the computing instructions, when executed on the one or more processors, further cause the one or more processors to perform:
detecting, in real-time, whether one or more non-compliant contribution attributes exist for a campaign contribution transaction received via the computer network and initiated by a contributor to the campaign, by:
identifying: (a) one or more contribution-limit-related rules associated with the campaign, or (b) one or more contributor-related rules associated with the campaign; and
making a second determination of:
(a) whether at least one of the contributor, the campaign, a contribution amount of the campaign contribution transaction, or an aggregated contribution amount by the contributor is associated with one or more second triggered rules of the one or more contribution-limit-related rules; or
(b) whether the identity of the contributor or campaign-fraud-related information associated with the contributor is associated with one or more third triggered rules of the one or more contributor-related rules;
after detecting whether the one or more non-compliant contribution attributes exist for the campaign contribution transaction, performing, a second operation associated with the one or more second triggered rules or the one or more third triggered rules, for the campaign contribution transaction, wherein the second operation comprises:
terminating the campaign contribution transaction without processing the campaign contribution transaction; or
processing, in real-time, a second online payment from the contributor based on the campaign contribution transaction; and
after processing occurs for the second online payment, creating, in response to a second payment confirmation for the second online payment associated with the second operation, a second record associated with the campaign contribution transaction in a second transaction database associated with the campaign.

32. A method being implemented via execution of computing instructions configured to run at one or more processors and stored at one or more non-transitory computer-readable media, the method comprising:
detecting, in real-time, whether one or more non-compliant disbursement attributes exist for a campaign disbursement transaction received via a computer network and initiated by a campaign to a vendor by:
identifying one or more vendor-related rules associated with the campaign; and
making a determination of whether the vendor or a disbursement type of the campaign disbursement transaction is associated with one or more triggered rules of the one or more vendor-related rules;
after detecting whether the one or more non-compliant disbursement attributes exist for the campaign disbursement transaction, performing, in response to the determination, an operation associated with the one or more triggered rules, for the campaign disbursement transaction, wherein the operation comprises:
terminating the campaign disbursement transaction without processing the campaign disbursement transaction; or
processing, in real-time, an online payment to the vendor based on the campaign disbursement transaction;
after processing occurs for the online payment, creating, in response to a payment confirmation for the online payment associated with the operation, a record associated with the campaign disbursement transaction in a transaction database associated with the campaign; and
generating, periodically according to a campaign report cycle, a report of one or more records stored in the transaction database based on one or more reporting rules associated with the campaign, wherein the one or more records comprise the record after processing occurs for the online payment.

33. The method in claim 32, wherein:
detecting whether the one or more non-compliant disbursement attributes exist for the campaign disbursement transaction further comprises verifying, in real-time, an identity of the vendor by one or more of:
using a third-party identity verifying service; or
matching vendor identifying information of the campaign disbursement transaction with entity data from one or more authority databases;
terminating the campaign disbursement transaction further comprises:
terminating the campaign disbursement transaction without processing the campaign disbursement transaction when the identity of the vendor is not verified; and
processing the online payment further comprises:
processing, in real-time, the online payment to the vendor based on the campaign disbursement transaction when the identity of the vendor is verified.

34. The method in claim 32 further comprising receiving, via the computer network from a campaign device of the campaign, transaction information for the campaign disbursement transaction, wherein the transaction information comprises vendor identifying information of the vendor, campaign identifying information of the campaign, the disbursement type, and a disbursement amount.

35. The method in claim 32, wherein processing the online payment to the vendor based on the campaign disbursement transaction further comprises:
transmitting, in real-time via the computer network, payment information for the online payment to a financial institution; and
receiving, in real-time via the computer network, the payment confirmation from the financial institution.

36. The method in claim 32, wherein the operation further comprises:
recording a payment entry of the campaign by an off-line payment option; and
receiving, via the computer network, the payment confirmation from a financial institution.

37. The method in claim 32 further comprising updating campaign rules based on a rule metadata received from a user device via the computer network, wherein:
the campaign rules comprise the one or more vendor-related rules.

38. The method in claim 37, wherein updating the campaign rules further comprises:
providing a user interface configured to be executed on the user device of a user for editing the rule metadata for a new rule or an existing rule of the campaign rules;
validating, in response to receipt of the rule metadata from the user device, the rule metadata based on one or more rule schemas; and
validating consistency of a rule set of one or more rules of the campaign rules associated with the rule metadata, wherein:
the rule set further comprises the new rule or the existing rule.

39. The method in claim 32, wherein:
at least one of the one or more triggered rules is associated with an entity type of the vendor or the disbursement type of the campaign disbursement transaction.

40. The method in claim 32 further comprising:
detecting, in real-time, whether one or more non-compliant contribution attributes exist for a campaign contribution transaction received via the computer network and initiated by a contributor to the campaign, by:
identifying: (a) one or more contribution-limit-related rules associated with the campaign, or (b) one or more contributor-related rules associated with the campaign; and
making a second determination of:
(a) whether at least one of the contributor, the campaign, a contribution amount of the campaign contribution transaction, or an aggregated contribution amount by the contributor is associated with one or more second triggered rules of the one or more contribution-limit-related rules; or
(b) whether the identity of the contributor or campaign-fraud-related information associated with the contributor is associated with one or more third triggered rules of the one or more contributor-related rules;
after detecting whether the one or more non-compliant contribution attributes exist for the campaign contribution transaction, performing, a second operation associated with the one or more second triggered rules or the one or more third triggered rules, for the campaign contribution transaction, wherein the second operation comprises:
terminating the campaign contribution transaction without processing the campaign contribution transaction; or
processing, in real-time, a second online payment from the contributor based on the campaign contribution transaction; and
after processing occurs for the second online payment, creating, in response to a second payment confirmation for the second online payment associated with the second operation, a second record associated with the campaign contribution transaction in a second transaction database associated with the campaign.
